(19) United States
(12) Patent Application Publication
(10) Pub. No.: US 2007/0093736 A1
(43) Pub. Date: Apr. 26, 2007

(54) S-shaped back scratcher, scrubber and applicator

(76) Inventor: Timothy Hebert, Vail, CO (US)

Correspondence Address: HOLLAND & KNIGHT LLP;ATTN: STEFAN V. STEIN/ IP DEPT., POST OFFICE BOX 1288, TAMPA, FL, 33601-1288, US

(21) Appl. No.: 11/583,620

(22) Filed: Oct. 19, 2006

Related U.S. Application Data
(60) Provisional application No. 60/728,198, filed on Oct. 19, 2005.

(51) Int. Cl. A61H 7/00

(52) U.S. Cl. 601/137; 601/135

(57) ABSTRACT

An S-shaped arcuate rod with an appliance or applicator on its lower terminal end to assist a person in washing, scrubbing, or scratching his back and for applying a dry or wet cleanser, lotion and/or conditioner to his back. The S-shape rod of the invention is easily grasped at various points along its curved shape, usually with one hand in the upper loop and the other hand along the middle of the S-shape, to define incremental hand positions. The various hand positions change the angle and fulcrum points which facilitate the comfortable placement and pressure applying action of the appliance or applicator.

### CROSS-REFERENCE TO RELATED APPLICATIONS

This application claims priority of provisional application No. 60/728,198, filed Oct. 19, 2005, the disclosure of which is hereby incorporated by reference herein.

### BACKGROUND OF THE INVENTION

1. Field of the Invention

This invention relates generally to an appliance to wash, scrub or scratch the human skin. This invention also relates to an applicator for applying a wet or dry body wash, cleanser, lotion or other topical preparations to human skin and then washing, scrubbing or scratching the human skin.

2. Description of the Background Art

Oftentimes, it is difficult to scratch one's back or to apply cleanser or lotion to one's back, or other difficult-to-reach anatomical parts, without the assistance of others. Further, the dispensation and application of such topical preparations usually requires applying them first to one's hands, then using the hands to apply the preparations to the remainder of the anatomy.

Presently, there exist numerous types of back scratchers. Representative United States patents directed to back scratchers include the following, the disclosure of each of which is hereby incorporated by reference herein:

U.S. Pat. No. 6,994,680 Automated back and belly scratcher

U.S. Pat. No. 6,221,034 Back scratcher

U.S. Pat. No. 6,110,132 Back scratcher

D414,295 Combination hand-held lotion applicator with back scratcher portion

U.S. Pat. No. 5,904,661 Back scratcher with a moving arm

U.S. Pat. No. 5,833,635 Combination back scratcher and body massager

D392,424 Back scratcher

D369,439 Folding back scratcher

D356,399 Back scratcher

D330,094 Back scratcher

D312,145 Back scratcher

D311,605 Back scratcher

U.S. Pat. No. 4,915,096 Combination back scratcher and body massager

U.S. Pat. No. 4,574,788 Facile back scratcher

D282,689 Back scratcher

D282,007 Combined massager and back scratcher

D280,449 Combined back scrubber and back scratcher with removable sponge element

D280,448 Combined back scrubber and back scratcher with removable sponge element

D277,512 Combined backscrubber and back scratcher with removable sponge element

D266,280 Back scratcher

D260,694 Back scratcher

U.S. Pat. No. 4,091,805 Vibrating back scratcher

U.S. Pat. No. 4,071,021 Mechanical back scratcher

As best demonstrated in U.S. Pat. Nos. 6,221,034, D312,145 and 4,574,788, some back scratchers comprise a handle for grasping and arcuately-shaped member extending therefrom. The arcuately-shaped member facilitates the person's ability to reach behind and scratch the area of his back that itches. Unfortunately, however, the handle is difficult to comfortably grasp in such a way that a desired level of pressure may be exerted during scratching.

As best illustrated in U.S. Patent D414,295, some back scratchers include the added functionality of a lotion applicator that allows the person to apply lotion to his back. However, the handle of the combination back scratcher and lotion applicator of U.S. Patent D414,295 is difficult to comfortably grasp during scratching or during application of the lotion to the person's back.

Therefore, it is an object of this invention to provide an improvement which overcomes the aforementioned inadequacies of the prior art devices and provides an improvement which is a significant contribution to the advancement of the back scratching, scrubbing and applicator art.

Another object of this invention is to provide a back scratching, scrubber and applicator that is comfortable to grasp to scratch one's back or to apply a topical preparation or cleanser to one's back and then scrub the back.

Another object of this invention is to provide a back scratching, scrubber and applicator that may be intuitively grasped and used by a person for back scratching, application of a topical preparation or cleanser or for back scrubbing.

Another object of this invention is to provide a back scratching, scrubber and applicator that is simple in design and economical to manufacture.

The foregoing has outlined some of the pertinent objects of the invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF THE INVENTION

The present invention relates to an apparatus designed to assist a person in washing, scrubbing, or scratching his skin and for applying a dry or wet cleanser, lotion and/or conditioner to hard-to-reach areas of his body. The invention is of particular usefulness in reaching areas of the body for those who cannot bend down or twist their bodies because of physical disability. For the purpose of summarizing this invention, this invention comprises an arcuate rod configured in a near figure-eight “S” curved shape. An appliance for scratching or scrubbing or applicator for applying a topical preparation or cleanser is attached to the end of the S-shaped rod.

The S-shape rod of the invention is easily grasped at various points along its curved shape, usually with one hand in the upper loop and the other hand along the middle of the S-shape, to define incremental hand positions. The various hand positions change the angle and fulcrum points which facilitate the comfortable placement and pressure applying action of the attachment.

The S-shaped rod of the invention may be constructed of various materials such as wood, plastic, resin, metal and may be constructed in various tubular shapes and sizes. It may be formed from a tubular round, triangular, rectangular or multi-angled rod or injected molded in any of these shapes. It may be constructed in various colors and transparencies, such as a clear plastic with metallic particles with a silver color suspended in the plastic, for example.

The S-shaped rod of the invention may be used by positioning one hand along the upper, more closed part of the S-shape which acts as a variable fulcrum point while the other hand is placed at various points along the middle area between the two curves. The outer portion of the smaller curve also provides a unique function in that it allows the hand to be placed farther out from the body while reaching across and in front of the body. The loop portion that is closest to the body functions better when the hand is positioned away from the body. Both hands may be used to guide while the pressure is applied from the opposite action of the hands (hands are rotated, fingers up or fingers down, depending on the action required). The fulcrum may be continuously switched from hand to hand as needed to achieve increased usefulness. The variable fulcrum point makes it possible to apply a constant pressure, from a very high amount to a very low and gentle amount, to all parts of the back as well as to many other body areas, as desired. The constant changing of the fulcrum point, the guiding action and the amount of pressure being applied, function in a fluid motion and is natural and intuitive to learn without any instructions and may be mastered in a matter of a few minutes.

The S-shaped rod of the invention may also employ a break-joint at a position around the middle of the length of the rod to further facilitate reaching various parts on the body.

The S-shape of the rod of the invention is aesthetically pleasing and results in a natural storage function as well. The curved loops on either end of the S-shaped rod create a built-in natural hanger which may be hung over a shower head, a water valve or any attached protrusion from a wall, post or even over a shower curtain rod, as a few examples.

The S-shaped rod of the invention may also comprise interchangeable components which may be permanently attached to the end of the S-shaped rod through holes, grooves or slits. It may be provided with changeable sponges or cloths that have varying amounts of abrasive surface that would attach to the end of the S-shaped rod via a pop-on or screw-on method. Each changeable applicator may have its own level of abrasive surface, (e.g., very mild coarseness to rough coarseness). The S-shaped rod of the invention may have the option of injecting a small amount of cleanser or lotion into the attaching cavity that would self distribute the substance based on use. The flexing of the S-shaped rod of the invention would therefore create a natural siphoning action that self regulates the dispensing of the cleanser or lotion from its center. The easy attaching and removal of the dispensing component also facilitates easy cleaning under a running faucet or in a body of water such as in a tub while taking a bath.

The shape of the variable surface components can be rectangular, triangular, or round and can be of various thicknesses or sizes and may attach via a small opening which leads to a larger opening (cavity) on the inside of the component. An inside cavity allows the interchangeable component to pop-on and pop-off of the bulbous end of the S-shaped rod. The attaching cavity of the component can vary in its shape with a similar resultant popping-on and popping-off of the apparatus.

More specifically, an angled shape of the cavity and attachment head would stabilize the applicator/component, while a round shape would allow the applicator/component to spin somewhat depending on the action, pressure, shape and coarseness of the applicator/component. Another method of attaching the above described applicators/components would be a screw-on shape such as those seen on mop, broom and other cleaning devices.

It can be seen by the foregoing that the invention may be manufactured in various versions, i.e., a version with a permanently-attached applicator/component, a version with one or more removable applicators/components and a version with one of more self-dispensing applicators/components.

Although the full curve of the smaller loop S-shaped rod is an important part of the proper use of the invention and completes the desired aesthetic shape, about 70% of the usefulness could be accomplished by shortening the smaller loop from the end at the upper end to just after the far side of the top of the loop.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is a side elevational view of the back scrubber of the invention;

FIG. 2 is a view of the FIG. 1 with the applicator of the back scrubber removed showing the mounting holes allowing other implements to be mounted thereto;

FIG. 3 is a view of FIG. 2 with a massaging ball installed on the lower end of the back scrubber for massaging one's back;

FIG. 4 is a perspective view of a person using the back scrubber of the invention for under-handed scrubbing of his back;

FIG. 5 is a perspective view of a person using the back scrubber of the invention over-handedly to reach over his back and scrub the upper portion of his shoulders;

FIGS. 6A and 6B are perspective views of the many ways that the back scrubber of the invention may be grasped to scrub different parts of a person's body.

Similar reference characters refer to similar parts throughout the several views of the drawings.

### DETAILED DESCRIPTION OF THE PREFERRED EMBODIMENT

The back scrubber of the invention comprises a rod 10 having a generally S-shaped configuration that defines an upper loop portion 12 and a lower loop portion 14. Preferably, the upper loop portion 12 defines an upper loop area 16 whereas the lower loop portion 14 defines a lower loop area 18. Preferably, the upper loop area 16 is appreciably less than the lower loop area 18.

The upper terminal end 20 of the upper loop portion 12 is preferably formed with an integral knob 22 (or artfully shaped head) that is roughly of a size that is contoured to fit in the palm of one's hand. Preferably, the upper terminal end 20 of the upper loop portion 12 is spaced from an intermediate portion 24 a distance sufficient to allow easy grasping of the knob 22 (or artfully shaped head) by the person's hand.

The lower loop portion 14 of the back scrubber 10 includes a lower terminal end 26 to which is affixed an appliance 28. Preferably, the lower terminal end 26 of the lower loop portion 14 is spaced appreciably away from the intermediate portion 24 to provide a large gap therebetween such that, as described hereinafter, the appliance 28 at the lower terminal end 26 of the lower loop portion 14 may be looped over a person's side or shoulders to urge the appliance 28 into engagement with the person's back.

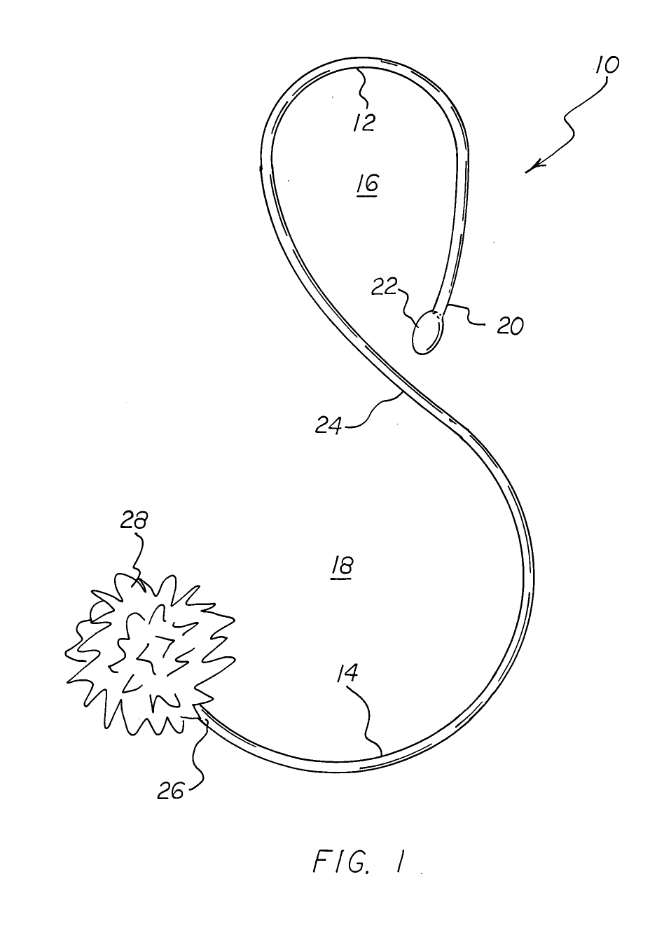

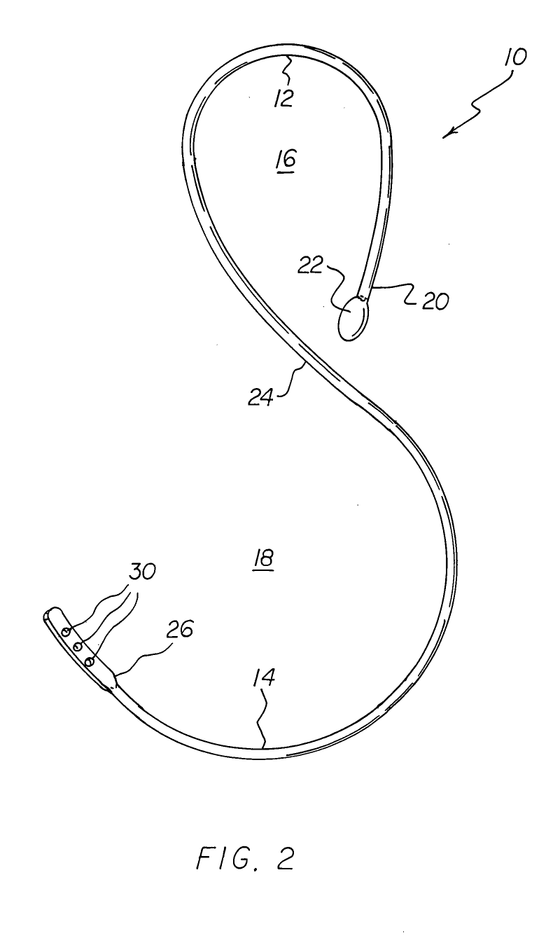

FIG. 2 is another view of FIG. 1 but with the appliance 28 removed to illustrate the mounting holes 30 formed in the lower terminal end 26 of the lower loop portion 14. Mounting holes 30 allow appliances 28 of different types to be removably connected to the lower terminal end 26.

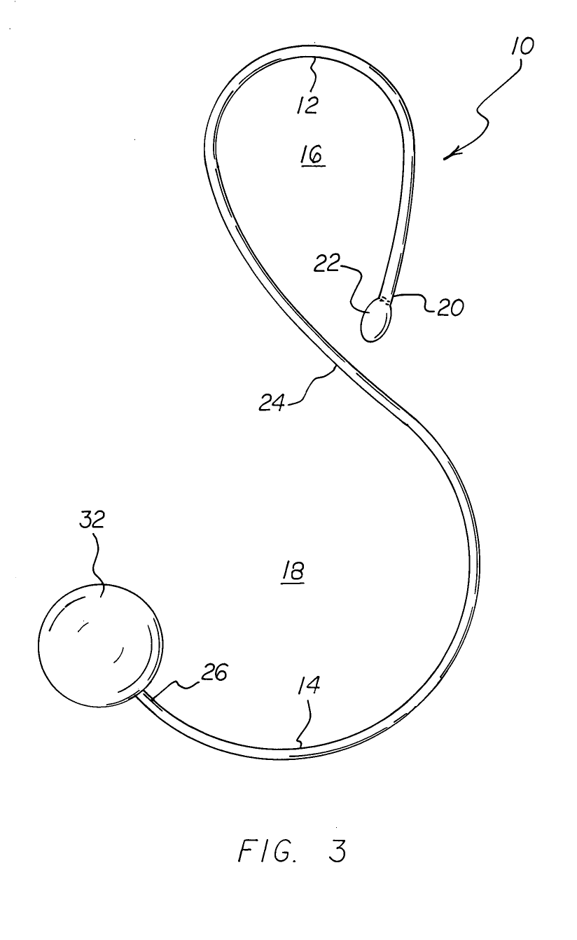

As used herein and in the claims, consistent with the spirit and scope of this invention, the term appliance 28 is defined to include any type of component that may be used for scratching an itchy area, for dispensing or applying a topical preparation or cleaner or for scrubbing. For example, as shown in FIG. 3, appliance 28 may comprise a massaging ball 32 which is removably installed onto the lower terminal end 26 by means of a mounting hole with protrusions that snap into the holes 30.

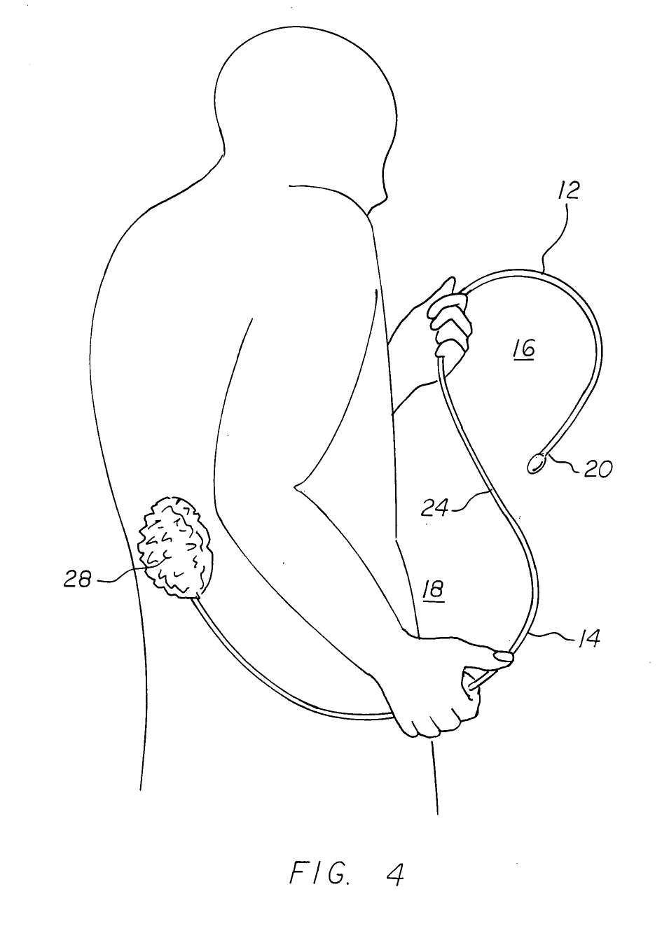

Referring now to FIG. 4, it is seen that the upper loop portion 12 of the S-shaped rod 10 of the invention may be easily grasped by a person's hand and, correspondingly, the intermediate portion 24 or the lower loop portion 14 may be easily grasped by the person's other hand, to position the appliance 28 into engagement with the person's back. Importantly, the two-handed grasping of the upper loop portion 12 and either the intermediate portion 24 or the lower loop portion 14 produces a fulcrum action to allow the person to easily reach all parts of his back and apply the desired pressure.

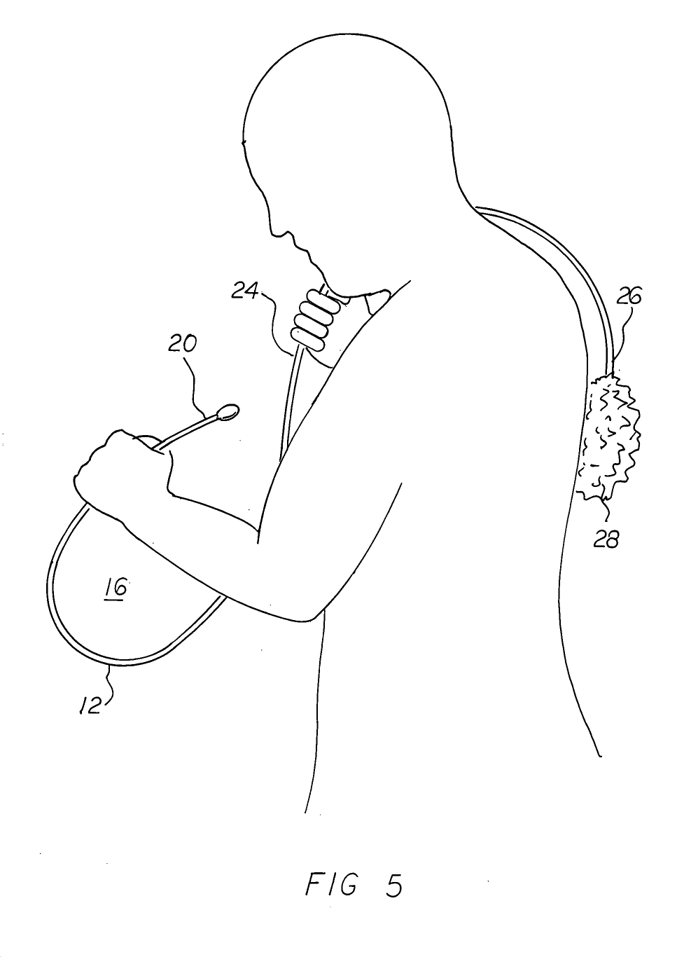

In FIG. 5, the S-shaped rod 10 of the invention is shown in use in an over-the-shoulder manner wherein the person's one hand grasps the upper loop portion 12 more toward the upper terminal end 20 and grasps the lower loop portion 14 with his other hand to easily extend the lower loop portion 14 over his shoulders to engage the appliance 28 to his upper back portion. Again, the two-handed grasping of the S-shaped rod 10 of the invention employs a fulcrum action to allow the person to easily position the appliance 28 in the desired position and to exert force thereto as desired.

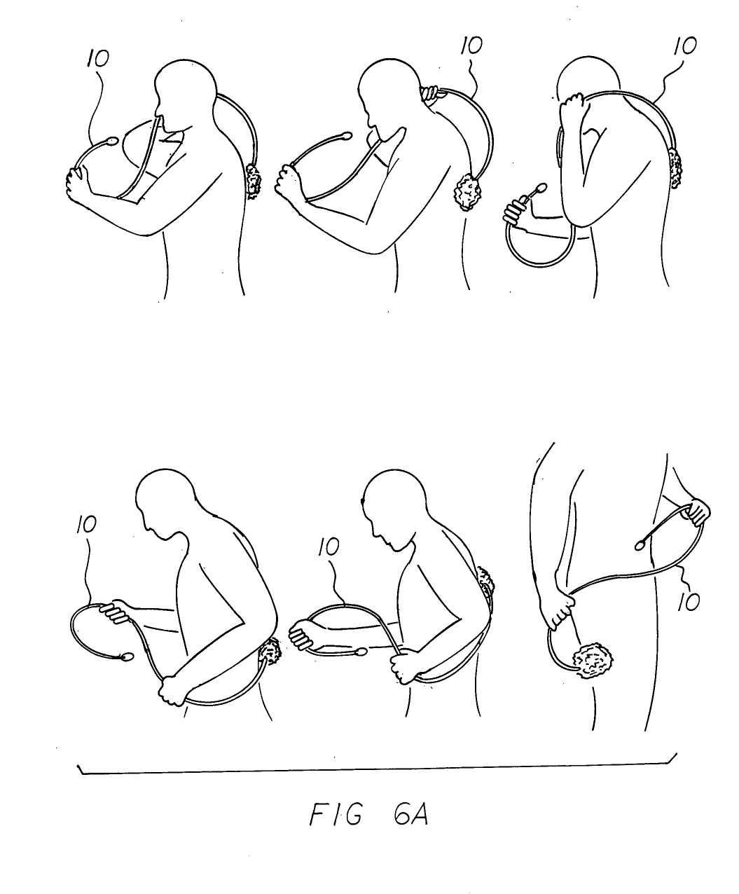

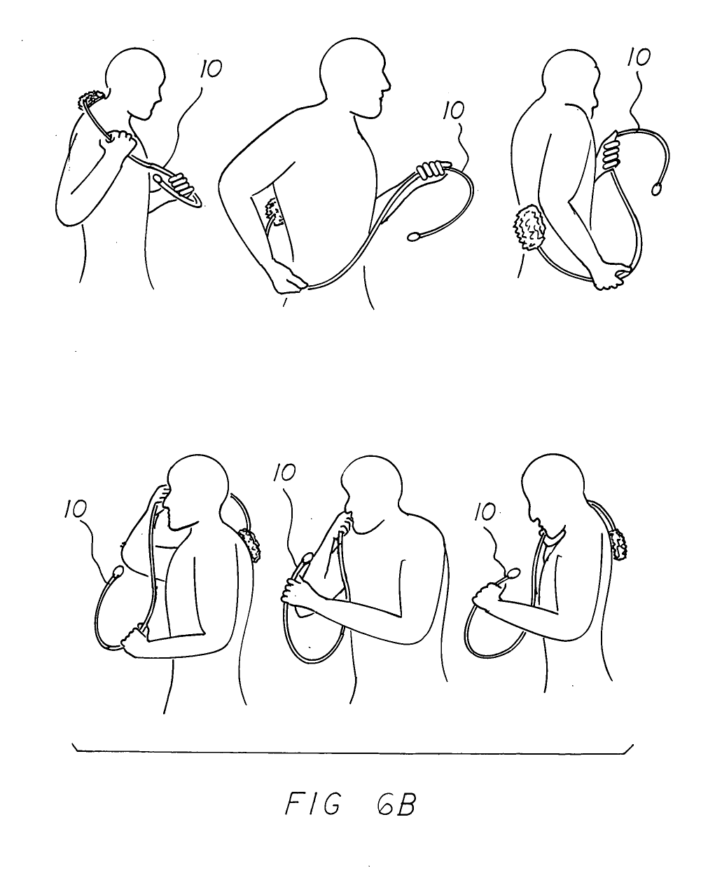

Finally, FIGS. 6A and 6B illustrate the many positions that the S-shaped rod 10 of the invention may be used to gain access to the different parts of a person's body. Notably, in each view, one of the person's hands is grasped upon the upper loop portion 12 and the other is grasped on either the intermediate portion 24 or the lower loop portion 14 to twist the S-shaped rod 10 in a fulcrum action to position the appliance 28 onto the desired part of his body while applying the desired level of pressure.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. An apparatus for scratching, applying a topical preparation or cleaner or for scrubbing to a person's back, comprising a rod having a generally S-shaped configuration that defines an upper loop portion and a lower loop portion.

2. The apparatus as set forth in claim 1, wherein the upper loop portion defines an upper loop area and the lower loop portion defines a lower loop area.

3. The apparatus as set forth in claim 2, wherein the upper loop area is appreciably less than the lower loop area.

4. The apparatus as set forth in claim 2, wherein an upper terminal end of the upper loop portion includes a knob.

5. The apparatus as set forth in claim 4, wherein the knob is contoured to fit in the palm of a person's hand.

6. The apparatus as set forth in claim 1, wherein an upper terminal end of the upper loop portion is spaced from an intermediate portion of the rod a distance sufficient to allow easy grasping of an upper terminal end of the upper loop portion.

7. The apparatus as set forth in claim 1, further including an appliance attached to the lower loop portion.

8. The apparatus as set forth in claim 7, wherein the appliance is attached to a lower terminal end of the lower loop portion.

9. The apparatus as set forth in claim 8, wherein the lower terminal end of the lower loop portion is spaced appreciably away from intermediate portion to provide a large gap therebetween such that the appliance at the lower terminal end of the lower loop portion may be looped over a person's side or shoulders to urge the appliance into engagement with the person's back.

10. The apparatus as set forth in claim 8, wherein the lower terminal end includes mounting holes allowing appliances of different types to be removably connected to the lower terminal end.

11. The apparatus as set forth in claim 1, wherein the appliance may be used for scratching an itchy area, for dispensing or applying a topical preparation or cleaner or for scrubbing.

12. The apparatus as set forth in claim 1, wherein the appliance comprises a massaging ball which is removably installed onto the lower terminal end.
